(19) United States
(12) Patent Application Publication
(10) Pub. No.: US 2021/0239515 A1
(43) Pub. Date: Aug. 5, 2021

(54) A COMMUNICATION DEVICE AND A SERVER FOR A WEIGHING SYSTEM FOR DYNAMIC WEIGHING OF VEHICLES

(71) Applicant: MOTUS WEIGHING AB, Göteborg (SE)

(72) Inventors: Stefan VALDEMARSSON, Lidköping (SE); Marcus TIMMERMAN, Götene (SE); Kristjan STEFANSSON, Lidköping (SE)

(73) Assignee: MOTUS WEIGHING AB, Göteborg (SE)

(21) Appl. No.: 17/053,156

(22) PCT Filed: May 8, 2019
(86) PCT No.: PCT/SE2019/050405

§ 371 Date: Nov. 5, 2020

(30) Foreign Application Priority Data
May 8, 2018 (SE) 1850543-8

(51) Int. Cl. G01G 23/42; G01G 19/03; G07C 5/08; G08G 1/017

(52) U.S. Cl. CPC G01G 23/42; G08G 1/017; G07C 5/0808; G01G 19/03

(57) ABSTRACT

A server and a communication device for a weighing system for dynamic weighing are disclosed. The communication device is configured to obtain supplementary weight information associated with a dynamic weighing event for a vehicle and transmit the supplementary weight information to the server. The communication device obtains the supplementary weight information prior to or after the dynamic weighing event for the vehicle. Thereby, registration of the vehicle can be performed prior to or after the dynamic weighing event and the vehicle does not have to stop at the dynamic weighing event.

### TECHNICAL FIELD

The present invention relates to a communication device and a server for a weighing system for dynamic weighing of vehicles. Furthermore, the present invention also relates to corresponding methods and a system.

### BACKGROUND

Road vehicles or railway vehicles are typically weighed to determine that the weight does not exceed limitations set by regulators, such as maximum vehicle total weight or maximum vehicle axle load on roads, railroads or bridges. Another typical application is to determine the cargo weight of the loaded vehicle.

When a vehicle weighing has been done there is a need to provide information associated with the obtained weight of the vehicle, such as the identity of the vehicle, identity of the driver, delivering customer, receiving customer, transportation company, description of goods, and so on. The conventional way of doing this is to place at least one stationary, so called weighing terminal, at the weighing scale. The weighing terminal often have inbuilt Radio Frequency Identification (RFID) reader, a keyboard and a printer. The driver uses RFID tags to identify the vehicle and may also enter more information if needed using the keyboard. Finally, a printed weighing ticket is received with all information gathered.

The weighing terminals are expensive and have to be served both in short term, such as when the paper roll have to be replaced, and in long term when e.g. failures can arise on the components of the weighing terminal. Another disadvantage is that the driver has to stop the vehicle in order to interact with the weighing terminal. This is a drawback especially in conjunction with the new weighing technology where an accurate weighing can be performed while driving over conventional weighbridges without stopping, so called dynamic weighing using dynamic weighing scales.

### SUMMARY

An objective of embodiments of the present invention is to provide a solution which mitigates or solves the drawbacks and problems of conventional solutions.

The above objectives are solved by the subject matter of the independent claims. Further advantageous implementation forms of the present invention can be found in the dependent claims.

According to a first aspect of the invention, the above mentioned and other objectives are achieved with a communication device for a weighing system for dynamic weighing of vehicles, the communication device being associated with a vehicle and being configured to
obtain supplementary weight information associated with a dynamic weighing event for the vehicle, wherein the supplementary weight information is obtained prior to or after the dynamic weighing event at a weighing bridge of a weighing scale so that the vehicle does not stop on the weighing bridge during the dynamic weighing event;
transmit the supplementary weight information to a server.

The communication device being associated with the vehicle implies that there is a connection between the communication device and the vehicle. This connection may e.g. be a logical connection between an identity of the communication device and an identity of the associated vehicle. Consequently, if the identity of the communication device is known the identity of the associated vehicle can be derived, and vice versa. The logical connection between the communication device and the vehicle may be permanent or temporary and may be provisioned in e.g. the communication device or the server. Both the communication device and the server may have access to up-to-date information about the logical connection between the communication device and the vehicle, e.g. through a database.

The communication device may be a standalone device with communication capabilities, such as a mobile phone, a laptop or any other suitable standalone communication device. However, the communication device may also be a part of the vehicle, e.g. a communication unit integrated in the vehicle with mentioned communication capabilities.

A vehicle in this context may e.g. be a road vehicle such as a truck, a bus, a dumper, or a car. In addition, a vehicle may be a railed vehicle such as a train or a tram.

Supplementary weight information can be other information related to the weighing, for example: what material is transported, place of loading and unloading, seller of material, buyer of material, classification number (governmental requirements), and so on, that can be provided to the server. This can for instance be done by the driver when a loading or unloading of the vehicle takes place.

A dynamic weighing event is a weighing event when the vehicle does not make a stop on the weighing bridge which means that the speed of the vehicle during the weighing event, on the weighing bridge, is higher than zero. This is in contrast to conventional static weighing when the vehicle must stop on the weighing bridge during weighing, which means that the speed of the vehicle during a static weighing event is zero at least in one time instance on the weighing bridge. Conventionally, the vehicle must stop on the weighing bridge for 10-30 seconds or more during static weighing.

The communication device according to the first aspect provides a number of advantages. One such advantage is that no weighing terminal is needed at the weighing scale where the driver should enter information, thereby a considerable amount of cost reduction can be achieved.

Another advantage of the communication device according to the first aspect is that there is no need to stop the vehicle on the weighing scale and thereby enabling the use of dynamic weighing scales instead of static weighing scales. On dynamic weighing scales the vehicle can drive over the weighing scale without stop and automatically achieve an accurate vehicle weight. To avoid stops for which ever reason, and fully make use of an automatic identification of a vehicle running over the weighing bridge, the supplementary weighing information can be delivered to the communication device at the natural stops, i.e. at loading and unloading, and not at the event of weighing. The avoidance of one extra stop imply a considerable cost saving. For example: assuming that the cost of a truck is approximately 90 EUR/h, and assuming time saving of 30 sec per weighing, and further assuming 100 weighings/day and per truck and assuming 300 operating days/year, the annual cost saving becomes: 30/3600 h*90 EUR/h*100 d*300 d/y=22 500 EUR per year. Also, other savings can be made due to not stop at weighing, such as less wear, and less fuel consumption (braking and acceleration at static weighing).

Still another advantage of the communication device according to the first aspect is that the communication device can be used for determining the position of the vehicle and thereby match the identity of the vehicle and/or the communication device with the weighing information obtained from a weighing scale.

In an embodiment of the first aspect, the supplementary weight information wherein the supplementary weight information comprises at least one of: company information, cargo information, load information, customer information, order information, regulatory information, and an identity of the vehicle.

In a further embodiment of the first aspect, the weighing bridge has a first spatial location, and the communication device is configured to
obtain the supplementary weight information at a second spatial location different from the first spatial location.

This embodiment has the advantage that the weighing scale need not be a static weighing scale where a stop on the weighing bridge is required. This provides further advantages of the use of a dynamic weighing scale since the vehicle can drive over the weighing bridge without have to stop.

In a further embodiment of the first aspect, the second spatial location is remote from the first spatial location.

This embodiment has the advantage that the flow of vehicles over the weigh bridge is not hindered when the user/driver needs to stop in the second spatial location in order to enter the supplementary information into the communication device. The second stop may be chosen to be a natural stop for instance at loading or unloading.

In a further embodiment of the first aspect, the dynamic weighing event is performed during a time period, and wherein the supplementary weight information is obtained at a time instance prior to or after the time period.

This embodiment has the advantage that the user/driver can use any time period to provide the supplementary information, whenever the user/driver anyway needs to stop prior or after the weighing event.

In a further embodiment of the first aspect, the communication device is configured to
obtain the supplementary weight information based on an input from a user of the communication device and/or from an administrator handling weighing orders/transactions.

An administrator can be a person working at a logistics firm or transportation firm handling orders and/or transactions.

This embodiment has the advantage that only the user/driver and/or administrator has the information about the details of the load and can register all needed information directly into the system in conjunction with the weighing event.

In a further embodiment of the first aspect, the communication device is configured to
receive a weighing ticket for the vehicle from the server in response to the transmission of the supplementary weight information.

This embodiment has the advantage that the weighing ticket can be received by the user/driver at any suitable location directly into the communication device of the vehicle and thereby there is no need for the user/driver to visit a special location where a conventional printer is stationed.

In a further embodiment of the first aspect, the communication device is configured to at least one of
present the weighing ticket to a user of the communication device; and
forward the weighing ticket to another communication device.

This embodiment has the advantage that the weighing ticket information can be provided to the user/driver independently of the location of the user/drive and furthermore be forwarded to, for instance a printer installed in the vehicle or to an overlying system.

In a further embodiment of the first aspect, the communication device is a standalone device or a part of the vehicle.

In a further embodiment of the first aspect, the communication device is configured to
obtain at least one of a position information, a speed, a direction and a timestamp for the vehicle at the dynamic weighing event; and further configured to
transmit at least one of the position information, the speed, the direction and the timestamp for the vehicle at the dynamic weighing event to the server.

This embodiment has the advantage that the server will be able to identify the weighing scale where the weighing event is taking place. The speed, the direction and the timestamp will serve as additional information to improve the matching between the position of the vehicle and the position of the weighing scale.

In a further embodiment of the first aspect, the communication device is configured to
obtain at least one of an identity of the vehicle and an identity of the weighing scale;
transmit at least one of the identity of the vehicle and the identity of the weighing scale to the server.

This embodiment has the advantage that for some cases the identity of the vehicle is not fully known even though there is a logical coupling between the vehicle and the communication device as mentioned before. Hence, there is a need for more information, e.g. from a camera or RFID placed at the weighing bridge location, for instance to confirm which specific trailer was coupled to a truck at the time of weighing event or which container the truck was equipped with at the time. When using recognition equipment at the place of the weighing bridge location to identify the vehicle, also the identity of the weighing bridge is known and can be transmitted to the communication device. In this way the matching between the weighing results and the vehicle identity has already taken place and need not be performed in the server.

In a further embodiment of the first aspect, obtain the identity of the vehicle comprises
obtain at least one of a position information, a speed, a direction and a timestamp for the vehicle at the dynamic weighing event;
determine the identity of the vehicle based on at least one of the position information, the speed, the direction and the timestamp for the vehicle at the dynamic weighing event.

The speed and direction for the vehicle at the dynamic weighing event implies that the vehicle never stops on the weighing bridge during the dynamic weighing event in contrast to static weighing. With the use of least one of the vehicle identification parameters, i.e.: a position information, a speed, a direction and a timestamp automatic identification of the vehicle is provided. Since, the vehicle is automatically identified there is no need for the user/driver to input any data or identification at the weighing event which means that the vehicle does not have to be stopped at the weighing event. Thereby, uncertainty in GPS-positioning, and hence identification of the vehicle being weighed, is considerably reduced by taking into account the three parameters available at a dynamic weighing event, i.e. the speed, the driving direction and the timestamp. This is not an option at a static weighing event where information about speed and direction are not available. Hence, the advantages with dynamic weighing can be fully exploited.

Generally, the received GPS-position is not precise and can be mixed up with the position of another weighing bridge close by where another vehicle happens to be weighed at the same time. In order to ensure that the vehicle identification is correct the user/driver may e.g. be prompted to compare a suggested location code presented by the wireless device, with a location code written on a display signage adjacent to the weigh bridge used. The user must e.g. push a button or provide any other suitable input to confirm the vehicle identification. This is part of non-automatic identification procedure in which the user or operator or driver or any other person have to perform at least one input action. It is also noted that if more vehicle identification parameters are used the higher accuracy in identification compared to when fewer vehicle identification parameters are used.

In a further embodiment of the first aspect, the vehicle has a speed that is higher than zero during the dynamic weighing event so that the vehicle does not stop on the weighing bridge during the dynamic weighing event.

This implies that the speed of the vehicle on the weighing bridge is always higher than zero.

According to a second aspect of the invention, the above mentioned and other objectives are achieved with a server for a weighing system for dynamic weighing of vehicles, the server being configured to:
receive weight information for a vehicle from a weighing scale, wherein the weight information for the vehicle has been obtained at a dynamic weighing event at a weighing bridge of the weighing scale;
receive supplementary weight information associated with the dynamic weighing event from a communication device, wherein the supplementary weight information has been obtained by the communication device prior to or after the dynamic weighing event so that the vehicle does not stop on the weighing bridge during the dynamic weighing event;
generate a weighing ticket for the vehicle based on the received weight information and the received supplementary weight information.

The server according to the second aspect provides a number of advantages. One such advantage is a centralized solution, i.e. inside a server which can serve a large amount of communication devices and weighing scales which e.g. facilitates service and the updating of new software. Furthermore, a server solution (e.g. connected to the internet) enables all the information handling associated with the weighing to be handled without any hardware located at the weighing scales. Hence no weighing terminals are needed at the weighing scale where the driver should enter information, thereby a considerable amount of cost reduction can be achieved.

Another advantage of the server according to the second aspect is that due to the server-communication device interaction according to embodiments of the invention there is no need to stop the vehicle on the weighing scale and thereby enabling the use of dynamic weighing scales instead of static weighing scales. On dynamic weighing scales the vehicle can drive over the weighing scale without stop and automatically achieve an accurate vehicle weight. To avoid stops for which ever reason, and fully make use of an automatic identification of a vehicle running over the weighing bridge, the supplementary weighing information can be delivered to the communication device at the natural stops, i.e. at loading and unloading, and not at the weighing event. The avoidance of one extra stop imply a considerable cost saving.

In an embodiment of the second aspect, the server is further configured to
receive at least one of a position information, a speed, a direction and a timestamp for the vehicle at the dynamic weighing event from the communication device;
generate the weighing ticket further based on at least one of the position, the speed, the direction and the timestamp received from the communication device.

This embodiment has the advantage that a weighing ticket can be generated without any conventional weighing terminals placed at the location of the weigh bridge, this enables the use of dynamic weighing technology without need to stop on the weigh bridge. With the information about a position, speed, direction and a timestamp for the vehicle at the weighing event the server is able to decide on which weighing scale the weighing event took place.

In a further embodiment of the second aspect, the server is further configured to
receive at least one of a speed, a direction and a timestamp for the vehicle at the dynamic weighing event from the weighing scale;
generate the weighing ticket further based on at least one of the speed, the direction and the timestamp received from the weighing scale.

This embodiment has the advantage of providing additional information to the server to ensure on which weighing scale the weighing event took place, i.e. the identity of the weighing scale. The server can compare the information obtained from the weighing scale about speed, direction and timestamp for the weighing event with the speed, direction and timestamp obtained from the communication device representing the identity of the vehicle. Hence, the matching can be improved.

In a further embodiment of the second aspect, the server is further configured to
generate the weighing ticket further based on at least one of the position information, the speed, the direction and the timestamp received from the communication device and the speed, the direction and the timestamp received from the weighing scale.

In a further embodiment of the second aspect, the server is further configured to
determine the identity of the vehicle based on at least one of the position information, the speed, the direction and the timestamp at the dynamic weighing event;
generate the weighing ticket further based on the determined identity of the vehicle.

In a further embodiment of the second aspect, the server is further configured to
receive at least one of an identity of the vehicle and an identity of the weighing scale from the communication device;
generate the weighing ticket further based on at least one of the received identity of the vehicle and the received identity of the weighing scale.

This embodiment has the advantage that no vehicle identification equipment is needed at the site of the weighing scale. When the server is handling many weighing events the server is able to decide which weighing results is referring to which vehicle and thereby a weighing ticket can be transferred to the correct user/driver.

In a further embodiment of the second aspect, the server is further configured to
receive an identity of the vehicle and an identity of the weighing scale from the weighing scale;
generate the weighing ticket further based on the received identity of the vehicle and the received identity of the weighing scale.

This embodiment has the advantage that in the case when there are insufficient conditions of using a communication device as a means to decide which vehicle is driving over a specific weighing bridge, vehicle identification equipment, such as cameras and RFID, can be installed at the site of the weighing scale. In this way dynamic weighing technology still can be used enabling a no-stop weighing procedure.

It should be noted that the server according to the second aspect can be configured to generate the weighing ticket further based on at least one of: the identity of the vehicle determined by the server, the identity of the vehicle received from the communication device, the identity of the weighing scale received from the communication device, the identity of the vehicle received from the weighing scale, and the identity of the weighing scale received from the weighing scale. That is, to generate the weighing ticket further based any combinations of one or more of the mentioned identities.

In a further embodiment of the second aspect, the server is configured to
generate the weighing ticket for the vehicle upon determine that the communication device matches the weighing information.

In a further embodiment of the second aspect, the server is configured to
determine that the communication device matches the weighing information based on at least one of: an identity of the vehicle received from the communication device, an identity of the weighing scale received from the communication device, an identity of the vehicle received from the weighing scale, an identity of the weighing scale received from the weighing scale or obtained by the server, and an identity of the vehicle determined by the server.

That is, determine that the communication device matches the weighing information based on any combinations of one or more of the above mentioned identities.

In a further embodiment of the second aspect, the server is configured to
transmit the weighing ticket for the vehicle to the communication device.

According to a third aspect of the invention, the above mentioned and other objectives are achieved with a method for a communication device being associated with a vehicle, the method comprises
obtaining supplementary weight information associated with a dynamic weighing event for the vehicle, wherein the supplementary weight information is obtained prior to or after the dynamic weighing event at a weighing bridge of a weighing scale so that the vehicle does not stop on the weighing bridge during the dynamic weighing event;
transmitting the supplementary weight information to a server.

The method according to the third aspect can be extended into embodiments corresponding to the embodiments of the communication device according to the first aspect. Hence, an embodiment of the method comprises the feature(s) of the corresponding embodiment of the communication device.

The advantages of the methods according to the third aspect are the same as those for the corresponding implementation forms of the communication device according to the first aspect.

According to a fourth aspect of the invention, the above mentioned and other objectives are achieved with a method for a server, the method comprises
receiving weight information for a vehicle from a weighing scale, wherein the weight information for the vehicle has been obtained at a dynamic weighing event at a weighing bridge of the weighing scale;
receiving supplementary weight information associated with the dynamic weighing event from a communication device, wherein the supplementary weight information has been obtained by the communication device prior to or after the dynamic weighing event so that the vehicle does not stop on the weighing bridge during the dynamic weighing event;
generating a weighing ticket for the vehicle based on the received weight information and the received supplementary weight information.

The method according to the fourth aspect can be extended into embodiments corresponding to the embodiments of the server according to the second aspect. Hence, an embodiment of the method comprises the feature(s) of the corresponding embodiment of the server.

The advantages of the methods according to the fourth aspect are the same as those for the corresponding implementation forms of the server according to the second aspect.

According to a fifth aspect of the invention the above mentioned and other objectives are achieved with a weighing system for dynamic weighing, the system comprises at least one communication device, at least one server and at least one weighing scale according to embodiments of the invention.

### BRIEF DESCRIPTION OF THE DRAWINGS

The appended drawings are intended to clarify and explain different embodiments of the present invention, in which:

FIG. 1 shows a weighing system accordance to an embodiment of the invention.

FIG. 2 shows a server accordance to an embodiment of the invention.

FIG. 3 shows a communication device accordance to an embodiment of the invention.

FIG. 4 shows a weighing scale accordance to an embodiment of the invention.

FIG. 5 shows a flowchart illustrating a position monitoring method according to an embodiment of the invention.

FIG. 6 shows a flowchart illustrating a method according to an embodiment of the invention.

### DETAILED DESCRIPTION

With dynamic weighing technology an accurate weighing of a vehicle can be performed while driving over conventional weighing bridges without stopping, using dynamic precision weighing methods. There are several advantages with the new dynamic weighing technology, e.g. increased capacity of the scale, time saving for the truck driver, less fuel consumption, less pollution, less noise, less wear and so on.

To fully make use of these advantages, conventional solutions for identification and registration of the vehicle has to be discarded. The conventional weighing terminals used for identification and registration of the vehicle requires the vehicle to stop to interact with the weighing terminal. Thereby, preventing a free flow of trucks moving over the weighbridge. Thus, it has been realised by the inventors that a solution is needed where the time and place for the identification and registration of the vehicle can be separated from the time and place for weighing of the vehicle.

The present invention provides a solution which captures readings from the weighing scale while the vehicle is driving over the weighbridge and can for instance use identification techniques to automatically identify the vehicle while driving, and furthermore uses a communication device for pre- or post-registration of supplementary weighing information. In this way, the identification and registration of the vehicle can be adapted to the natural flow of cargo from the place of loading to the place of unloading using these two natural stops to registrate supplementary weighing information. Of course, any other stop or time can be used to registrate supplementary weighing information as long as the supplementary weighing information about the transported cargo is at hand.

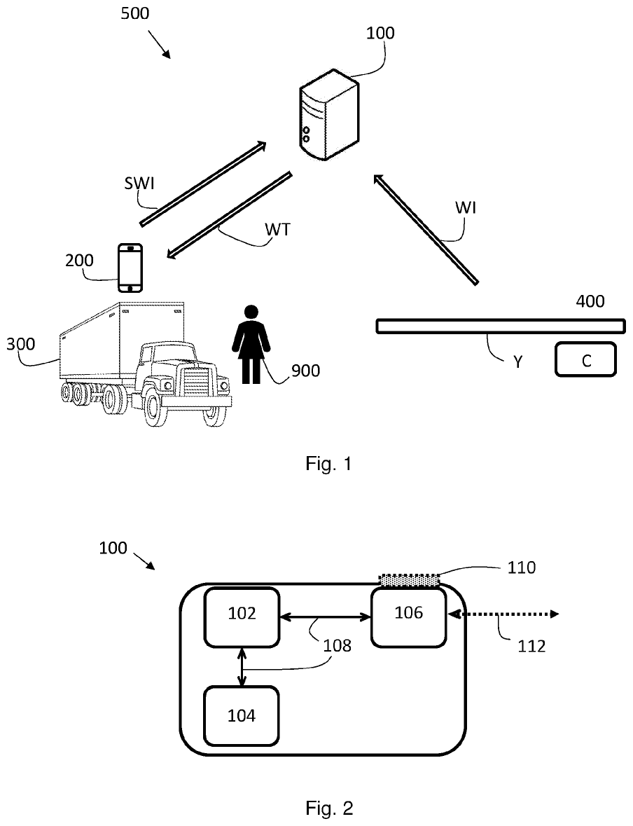

FIG. 1 shows schematically a weighing system 500 for dynamic weighing according to an embodiment of the invention. The weighing system 500 comprises a server 100, a communication device 200, and a weighing scale 400. In the weighing system 500, information associated with a vehicle 300 and its weight is exchanged between the server 100, the communication device 200, and the weighing scale 400. The information may be transmitted/signaled/transferred between communication nodes in the weighing system 500 using any communication method known in the art, such as wireless and/or wired communication over a wireless and/or wired communication systems, respectively. The weighing system 500 shown in FIG. 1 only comprises one server 100, one communication device 200, and one weighing scale 400. However, the invention is not limited thereto. In further embodiments, the weighing system 500 may instead comprise more than one server 100, communication device 200, weighing scale 400.

The communication device 200 is associated with the vehicle 300, meaning that there is a connection between the communication device 200 and the vehicle 300. The communication device 200 may e.g. be registered in the server 100 as associated with/connected to the vehicle 300. As shown in FIG. 1, the communication device 200 may be a standalone device with communication capabilities, such as a mobile phone, a laptop or any other suitable standalone communication device. However, the communication device 200 may also be a part of the vehicle, e.g. a communication unit integrated in the vehicle 300 with mentioned communication capabilities.

The weighing scale 400 comprise a weighing bridge Y and a weighing circuit C and is arranged for performing dynamic weighing of vehicles driving over the weighing bridge Y. At a dynamic weighing event, i.e. when a vehicle drives over the weighing bridge Y without making a stop, the weighing scale 400 determines weight information for the vehicle 300. Weight information may be any weight information gathered by the weighing scale 400 in the weighing procedure such as a determined weight of the vehicle but also other information associated with the weight information and/or the weighing event itself, such as e.g. direction of the vehicle, speed of the vehicle warnings, etc.

According to embodiments of the invention a dynamic weighing event for a vehicle 300 is performed at the weighing bridge Y of the weighing scale 400. At the dynamic weighing event, the weighing scale 400 obtains weight information WI for the vehicle 300. The obtained weight information WI is transmitted to the server 100, as shown in FIG. 1. Prior to, or after the dynamic weighing event at the weighing bridge Y of the weighing scale 400, the communication device 200 obtains supplementary weight information SWI associated with the dynamic weighing event for the vehicle 300. The communication device 200 transmits the obtained supplementary weight information SWI to the server 100, as shown with an arrow in FIG. 1.

Thus, the server 100 is configured to receive weight information WI for the vehicle 300 from the weighing scale 400, as well as supplementary weight information SWI associated with the dynamic weighing event from the communication device 200. As described above, the weight information WI for the vehicle 300 has been obtained by the weighing scale 400 at the dynamic weighing event, while the supplementary weight information SWI has been obtained by the communication device 200 prior to or after the dynamic weighing event. Based on the received weight information WI from the weighing scale 400 and the received supplementary weight information SWI from the communication device 200, the server 100 generates a weighing ticket WT for the vehicle 300. The weighing ticket WT may include the received weight information WI and the received supplementary weight information SWI and may further include additional information associated with the dynamic weighing event. The weighing ticket WT may be transmitted to the communication device 200, as shown with an arrow in FIG. 1. Hence, the communication device 200 is in such an embodiment configured to receive a weighing ticket WT for the vehicle 300 from the server 100. The weighing ticket WT may in embodiments be received in response to the transmission of the supplementary weight information SWI to the server 100. In other words, upon receiving supplementary weight information SWI associated with a dynamic weighing event for the vehicle 300 from the communication device 200, the server 100 may transmit the weighing ticket WT to the communication device 200. When the communication device 200 receives a weighing ticket WT, the communication device 200 may present the weighing ticket WT to a user/driver of the communication device 200 and/or forward the weighing ticket WT to another communication device, such as e.g. printer or a communication device or server in a logistic or business system.

FIG. 2 shows an embodiment of the server 100. In this embodiment, the server 100 comprises a processor 102, a memory 104, and a transceiver 106. The server 100 is coupled to the memory 104 and the transceiver 106 with coupling means 108 known in the art. The server 100 may further be configured for wireless and/or wired communications in wireless and/or wired communication systems, respectively. The wireless communication capability is provided with an antenna 110 coupled to the transceiver 106, while the wired communication capability is provided with a wired communication interface 112 coupled to the transceiver 106.

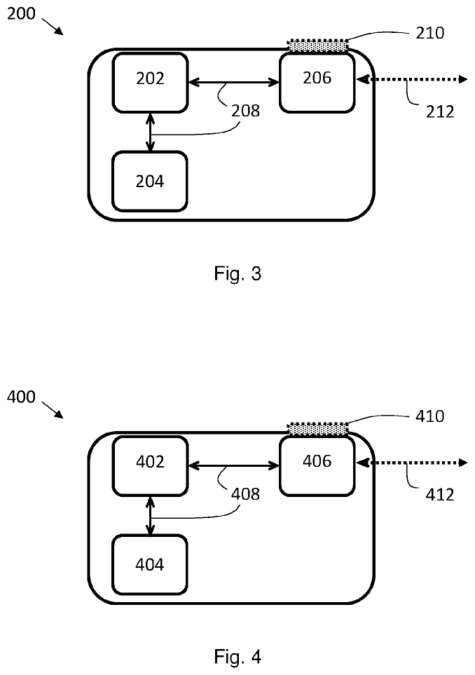

FIG. 3 shows an embodiment of the communication device 200. In this embodiment, the communication device 200 comprises a processor 202, a memory 204, and a transceiver 206. The communication device 200 is coupled to the memory 204 and the transceiver 206 with coupling means 208 known in the art. The communication device 200 may further be configured for wireless and/or wired communications in wireless and/or wired communication systems, respectively. The wireless communication capability is provided with an antenna 210 coupled to the transceiver 206, while the wired communication capability is provided with a wired communication interface 212 coupled to the transceiver 206.

FIG. 4 shows an embodiment of the weighing scale 400. In this embodiment, the weighing scale 400 comprises a processor 402, a memory 404, and a transceiver 406. The weighing scale 400 is coupled to the memory 404 and the transceiver 406 with coupling means 408 known in the art. The weighing scale 400 may further be configured for wireless and/or wired communications in wireless and/or wired communication systems, respectively. The wireless communication capability is provided with an antenna 410 coupled to the transceiver 406, while the wired communication capability is provided with a wired communication interface 412 coupled to the transceiver 406.

The server 100, communication device 200 and weighing scale 400 may conform to established communication standards, such as LTE, LTE Advanced, New Radio 5G, WiFi, etc. but are not limited thereto.

The weighing scale 400 may also comprise further components, units, elements, and devices not shown in FIG. 4. Non-limiting examples of such components, units, elements, and devices are a weighing bridge Y and a weighing circuit C (shown in FIG. 1). Mentioned weighing circuit C may comprise at least a first set of load sensors and a second set of load sensors coupled to a weight indicator. The first set of load sensors is arranged at the first side of the weighing bridge Y and the second set of load sensors is arranged at the second side of the weighing bridge Y. In an embodiment, the vehicle 300 passes over the weighing bridge Y from the first side to the second side, causing weight signals to be generated by the first set of load sensors and the second set of load sensors. These weight signals are transferred to the weight indicator and to a processing device, such as e.g. the processor 402, coupled to the weighing circuit C. The processing device may be a standalone device. However, the processing device may in some embodiments be part of the weight indicator or another device of the weighing scale 400.

As described with reference to FIG. 1, the communication device 200 is associated with a vehicle 300 and further configured to obtain supplementary weight information associated with a dynamic weighing event for the vehicle 300. The supplementary weight information may e.g. be associated to company name, commodity, order number, transporting company, vehicle identity, delivering customer, receiving customer, transportation company, description of goods; and generally useful information related to the weighing, such as what material is transported, loading and unloading site, seller of material, buyer of material, classification number (governmental requirements), etc. The communication device 200 may obtain the supplementary weight information based on an input from a user/driver 900 of the communication device 200 or an administrator handling transport orders or transactions. The user/driver 900 may e.g. enter the supplementary weight information using an input device of the communication device 100, such as a keyboard or microphone or camera of the communication device 200. However, also other input devices or means can be used for inputting the supplementary weight information. The user 900 of the communication device 200 can e.g. be the driver of the vehicle 300 or a person working with loading or unloading of the vehicle 300.

The supplementary weight information is obtained prior to or after the dynamic weighing event at the weighing bridge Y of the weighing scale 400. Thus, the place and time where the supplementary weight information is obtained is separated from the place and time where the dynamic weighing is performed. In other words, if the dynamic weighing event is performed during a time period, the supplementary weight information may be obtained at a time instance prior to or after the time period. Furthermore, the weighing bridge Y may have a first spatial location and the communication device 200 may obtain the supplementary weight information at a second spatial location different from the first spatial location. The second spatial location is remote from the first spatial location, e.g. not at the plant of the weighing scale. For example, the second spatial location may correspond to a loading site located in one part of a town or country, while the first spatial location may correspond to a location of a weighing scale 400 located in a different part of the town or country or even in a different country.

By separating the place and time where the supplementary weight information is obtained from the place and time where the dynamic weighing is performed, the user 900 of the communication device 200 does not have to stop the vehicle 300 during the dynamic weighing event to enter the supplementary weight information. Instead the supplementary weight information can be entered prior to the dynamic weighing event, e.g. at a loading site or other suitable site where a stop is anyway required. Alternatively, the supplementary weight information can be entered after the dynamic weighing event, e.g. at an unloading site or other suitable site where a stop is anyway required.

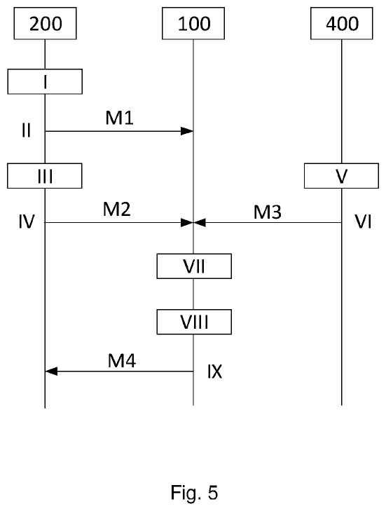

As described above, the server 100 receives supplementary weight information from the communication device 200 and weight information from the weighing scale 400. The server 100 matches the received supplementary weight information with the received weight information, to be able to generate a weighing ticket and transmit the weighing ticket to the correct communication device 100. To match the received supplementary weight information with the received weight information may mean to verify that the communication device 200 transmitting the supplementary weight information matches the weight information from the weighing scale 400, i.e. that the communication device 200 is verified to be the communication device 200 associated with the vehicle 300 for which weight information has been received from the weight scale 400, or vice versa. The verification may e.g. be performed by comparing information associated with the communication device 200 and/or the vehicle 300 with information associated with the weight information for the vehicle 300, as will now be described with reference to FIG. 5.

FIG. 5 shows matching of a communication device 200 to weight information using information received from the communication device 200 according to an embodiment of the invention. In the embodiment shown in FIG. 5, the communication device 200 obtains and transmits supplementary weight information to a server 100 prior to a dynamic weighing event for the vehicle 300. Hence, in step I the communication device 200 obtains supplementary weight information associated with a dynamic weighing event for the vehicle 300 at a weighing bridge Y of a weighing scale 400. The communication device 100 further transmits the obtained supplementary weight information to the server 100 in a first communication message Ml, as shown in step II.

When the dynamic weighing event for the vehicle 300 at the weighing scale 400 takes place, both the communication device 200 and the weighing scale 400 obtains information associated with the dynamic weighing event and transmits the obtained information to the server 200. The information is obtained at the dynamic weighing event for the vehicle 300 which may herein be understood to mean during the dynamic weighing event, e.g. from a time instance at which the vehicle 300 approaches the weighing bridge Y to a time instance at which the vehicle 300 has driven over and left the weighing bridge Y. In FIG. 5, the communication device 200 and the weighing scale 400 perform obtaining of information associated with the dynamic weighing event in steps III and V, respectively. As both step III and V are performed at the dynamic weighing event, they are performed at approximately the same time or at least close to each other in time. The transmission of the obtained information to the server 100, is performed in step IV by the communication device 200 and in step VI by the weighing scale 400. In FIG. 5, step IV and VI are shown to be performed at the same time. However, depending on implementation and processing in the communication device 200 and the weighing scale 400, step IV and VI may in embodiments instead be performed at different times.

The information obtained by the communication device 200 in step III may be at least one of a position information, a speed, a direction, and a timestamp for the vehicle 300 at the dynamic weighing event. The communication device 200 may obtain the position for the vehicle 300 at the dynamic weighing event using any positioning techniques such as GPS, mobile location services, etc. Furthermore, the communication device 200 may obtain the speed and direction for the vehicle 300 at the dynamic weighing event using any technique known in the art, e.g. using gyro-meters, accelerometers, positioning systems, or suitable sensors. To obtain the timestamp for the vehicle 300 at the dynamic weighing event the communication device 200 may e.g. use an internal clock.

When the communication device 200 has obtained the at least one position information, speed, direction, and timestamp in step III, the communication device 200 transmits the at least one obtained position information, speed, direction, and timestamp for the vehicle 300 at the dynamic weighing event to the server 100 in a second communication message M2, as shown in step IV. In an embodiment the second communication message M2 also comprises at least one identity of the vehicle 300 and an identity of the weighing scale 400 obtained by the communication device 100.

The information obtained by the weighing scale 400 in step V may be weight information, as well as at least one of a speed, a direction and a timestamp for the vehicle 300 at the dynamic weighing event. The weighing scale 400 may obtain the speed and the direction for the vehicle 300 at the dynamic weighing event using any technique known in the art, e.g. using gyro-meters, accelerometers, positioning systems or suitable sensors. Furthermore, when the vehicle 300 drives over the weighbridge Y of the weighing scale 400, the weighing scale 400 can obtain the speed from the weight information sampled during the passage. Also, the driving direction over the weighbridge Y may be given by the same procedure and the orientation of the weighbridge relative to compass direction, such as a compass direction, may further be registered in a database. To obtain the timestamp for the vehicle 300 at the dynamic weighing event the weighing scale 400 may e.g. use an internal clock.

When the weighing scale 400 has obtained the weight information and the at least one speed, direction, and timestamp in step V, the weighing scale 400 transmits the obtained weight information and the at least one speed, direction and timestamp for the vehicle 300 at the dynamic weighing event to the server 100 in a third communication message M3, as shown in step VI. In embodiments, the third communication message M3 may further comprise a position information for the weighing scale 400. The position information for the weighing scale 400 may in this case e.g. be pre-configured in the weighing scale 400.

The server 100 receives the at least one position, speed, direction and timestamp for the vehicle 300 at the dynamic weighing event from the communication device 200 in the second communication message M2. Furthermore, the server 100 receives the at least one speed, direction and timestamp for the vehicle 300 at the dynamic weighing event from the weighing scale 400 in the third communication message M3. Based on the received information, the server 100 may in step VII match the communication device 200 with the weighing information for the vehicle 300 received from the weighing scale 400. Step VII may comprise the server 100 comparing information received from the communication device 200 with information obtained internally in the server 100 or received from the weighing scale 400. For example, the server 100 may compare the position information received from the communication device 200 with a position information for the weighing scale 400. As previously described, the position information for the weighing scale 400 may be comprised in the third communication message M3, i.e. received from the weighing scale 400. However, the server 100 may instead obtain the position information for the weighing scale 400 from an internal or external database or from another server in the weighing system 500 or connected to the weighing system 500. Alternatively, the position information for the weighing scale 400 may be pre-configured in the server 100. If the position information received from the communication device 200 corresponds to the position information for the weighing scale 400 obtained internally or received from the weighing scale 400, the communication device 200 is considered to match the weighing information for the vehicle 300 received from the weighing scale 400. That the position information correspond to each other can herein be understood to mean that they are equal or do not differ more than a spatial threshold value, i.e. the positions are spatially/geographically close to each other.

Step VII may further comprise the server 100 comparing information related to the speed, direction and/or timestamp received from the communication device 200 with information related to the speed, direction and/or timestamp received from the weighing scale 400. If the speeds, directions, and/or timestamps corresponds to each other the communication device 200 is considered to match the weighing information for the vehicle 300 received from the weighing scale 400. That the speeds, directions, and/or timestamps correspond to each other could herein be understood to mean that they are equal or do not differ more than a threshold value related to the speed, direction and/or timestamp.

In embodiments of the invention, the server 100 is configured to determine the identity of the vehicle 300 based on at least one of the position information, the speed, the direction and the timestamp at the dynamic weighing event, and further configured to generate the weighing ticket further based on the determined identity of the vehicle 300. Thereby, the server does not need to receive the identity of the vehicle 300 from the communication device and/or the weighing scale 400 which means reduced communication payload; or the server 100 can use the determined identity of the vehicle to compare with an received identity of the vehicle for improving identification accuracy and hence also matching accuracy.

When a match between the communication device 200 and the weighing information for the vehicle 300 received from the weighing scale 400 has been determined in step VIII, the server 100 generates a weighing ticket for the vehicle 300 in step VIII. The server 100 generates the weighing ticket for the vehicle 300 based on the supplementary weight information received in the first communication message M1 and the weight information received in the third communication message M3. As the weighing ticket may be generated in step VIII based on a match in step VII, the server 100 may generate the weighing ticket further based on at least one of the position, the speed, the direction and the timestamp received from the communication device 200. Furthermore, the server 100 may generate the weighing ticket further based on at least one of the speed, the direction and the timestamp received from the weighing scale 400. The generated weighing ticket can further be transmitted to the communication device 200 in a fourth communication message M4, as shown in step IX.

FIG. 5 shows an embodiment in which the communication device 200 obtains and transmits supplementary weight information associated with a dynamic weighing event to the server 100 prior to the dynamic weighing event. However, the communication device 200 may in embodiments instead obtain and transmit supplementary weight information associated with the dynamic weighing event to the server 100 after the dynamic weighing event. In this case, the communication device 200 would perform step I and step II after steps III to VI has been performed. According to embodiments of the invention a communication device 200 may be matched to weight information for the vehicle 300 based on information from the weighing scale 400 instead of or complementary to the information from the communication device 200.

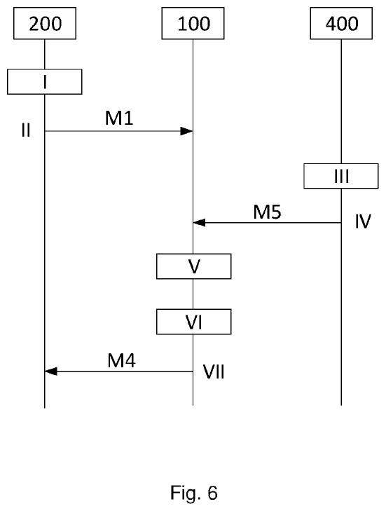

FIG. 6 shows such an embodiment, in which the server 100 matches the communication device 200 with the weighing information for the vehicle 300 based on information from the weighing scale 400. In the embodiment shown in FIG. 6, the communication device 200 obtains and transmits supplementary weight information to a server 100 prior to a dynamic weighing event for the vehicle 300. Hence, in step I the communication device 200 obtains supplementary weight information associated with a dynamic weighing event for the vehicle 300 at a weighing bridge Y of a weighing scale 400. The communication device 200 further transmits the obtained supplementary weight information to the server 100 in a first communication message Ml, as shown in step II.

The information from the weighing scale 400 used to match the communication device 200 with the weighing information for the vehicle 300 may be an identity of the vehicle 300 and an identity of the weighing scale 400. In FIG. 6, the weighing scale 400 obtains the identity of the vehicle 300 and the identity of the weighing scale 400 in step III. The weighing scale 400 may obtain the identity of the vehicle 300 at the dynamic weighing event e.g. by reading a RFID tag or scanning a bar code associated with the vehicle 300. In addition, the identity of the vehicle 300 may e.g. be obtained by using license plate recognition techniques. The identity of the weighing scale 400 may e.g. be pre-configured in the weighing scale 400. Step III may further comprise the weighing scale 400 obtaining weight information for the vehicle 300 at the dynamic weighing event, as described with reference to FIG. 5.

The weighing scale 400 transmit the information obtained in step III to the server 100. In the embodiment shown in FIG. 6, the weighing scale 400 transmits the identity of the vehicle 300 and the identity of the weighing scale 400, as well as weight information for the vehicle 300, to the server 100 in a fifth communication message M5, as shown in step IV. However, the weight information for the vehicle 300 may in embodiments instead be transmitted in a separate communication message, such as e.g. the third communication message shown in FIG. 5.

The server 100 receives the identity of the vehicle 300 and the identity of the weighing scale 400 from the weighing scale 400. The server 100 may use the received identity of the vehicle 300 and identity of the weighing scale 400 to match the communication device 200 with the weighing information for the vehicle 300 in step V. For example, the server 100 may compare the identity of the vehicle 300 received from the weighing scale 400 with an identity of the vehicle 300 derived from information received from the communication device 200 in the first communication message M1. If the two identities are the same the communication device 200 is considered to matches the weighing information for the vehicle 300. In this case, the server 100 generates a weighing ticket in step VI, where the weighing ticket is further based on the received identity of the vehicle 300 and the received identity of the weighing scale 400. The generated weighing ticket can further be transmitted to the communication device 200 in a fourth communication message M4, as shown in step VII. In case the second communication message M2 from the communication device 100 also comprises at least one identity of the vehicle 300 and an identity of the weighing scale 400, such identities can be used to determine if the communication device 200 matches the weighing information for the vehicle 300.

Any method according to embodiments of the invention may be implemented in a computer program, having code means, which when run by processing means causes the processing means to execute the steps of the method. The computer program is included in a computer readable medium of a computer program product. The computer readable medium may comprise essentially any memory, such as a ROM (Read-Only Memory), a PROM (Programmable Read-Only Memory), an EPROM (Erasable PROM), a Flash memory, an EEPROM (Electrically Erasable PROM), or a hard disk drive.

Moreover, it is realized by the skilled person that embodiments of the server 100, the communication device 200, and the weighing scale 400 comprise the necessary communication capabilities in the form of e.g., functions, means, units, elements, etc., for performing the present solution. Examples of such functions, means, units, elements are: processors, memory, buffers, control logic, encoders, decoders, rate matchers, de-rate matchers, mapping units, multipliers, decision units, selecting units, switches, interleavers, de-interleavers, modulators, demodulators, inputs, outputs, antennas, amplifiers, receiver units, transmitter units, DSPs, MSDs, TCM encoder, TCM decoder, power supply units, power feeders, communication interfaces, communication protocols, etc. which are suitably arranged together for performing the present solution.

Especially, the processors 102, 202, 402 of the server 100, the communication device 200, and the weighing scale 400 may comprise, e.g. one or more instances of a Central Processing Unit (CPU), a processing unit, a processing circuit, a processor, an Application Specific Integrated Circuit (ASIC), a microprocessor, or other processing logic that may interpret and execute instructions. The expression “processor” may thus represent a processing circuitry comprising a plurality of processing circuits, such as, e.g., any, some or all of the ones mentioned above. The processing circuitry may further perform data processing functions for inputting, outputting, and processing of data comprising data buffering and device control functions, such as call processing control, user interface control, or the like.

Finally, it should be understood that the invention is not limited to the embodiments described above, but also relates to and incorporates all embodiments within the scope of the appended independent claims.

1. A communication device for a weighing system for dynamic weighing of vehicles, the communication device being associated with a vehicle and being configured to
obtain supplementary weight information associated with a dynamic weighing event for the vehicle, wherein the supplementary weight information is obtained prior to or after the dynamic weighing event at a weighing bridge of a weighing scale so that the vehicle does not stop on the weighing bridge during the dynamic weighing event;
transmit the supplementary weight information to a serve.

2. The communication device according to claim 1, wherein the supplementary weight information comprises at least one of: company information, cargo information, load information, customer information, order information, regulatory information, and identity of the vehicle.

3. The communication device according to claim 1, wherein the weighing bridge has a first spatial location, and wherein the communication device is configured to
obtain the supplementary weight information at a second spatial location different from the first spatial location.

4. The communication device according to claim 1, wherein the dynamic weighing event is performed during a time period, and wherein the supplementary weight information is obtained at a time instance prior to or after the time period.

5. The communication device according to claim 1, configured to
obtain the supplementary weight information based on an input from a user of the communication device and/or from an administrator handling weighing orders/transactions.

6. The communication device according to claim 1, configured to
receive a weighing ticket for the vehicle from the server in response to the transmission of the supplementary weight information.

7. The communication device according to claim 6, configured to at least one of
present the weighing ticket to a user of the communication device; and
forward the weighing ticket to another communication device.

8. The communication device according to claim 1, configured to
obtain at least one of a position information, a speed, a direction and a timestamp for the vehicle at the dynamic weighing event; and further configured to
transmit at least one of the position information, the speed, the direction and the timestamp for the vehicle at the dynamic weighing event to the server.

9. The communication device according to claim 1, configured to
obtain at least one of an identity of the vehicle and an identity of the weighing scale;
transmit at least one of the identity of the vehicle and the identity of the weighing scale to the server.

10. The communication device according to claim 9, wherein obtain the identity of the vehicle comprises
obtain at least one of a position information, a speed, a direction and a timestamp for the vehicle at the dynamic weighing event;
determine the identity of the vehicle based on at least one of the position information, the speed, the direction and the timestamp for the vehicle at the dynamic weighing event.

11. A server for a weighing system for dynamic weighing of vehicles, the server being configured to
receive weight information for a vehicle from a weighing scale, wherein the weight information for the vehicle has been obtained at a dynamic weighing event at a weighing bridge of the weighing scale;
receive supplementary weight information associated with the dynamic weighing event from a communication device, wherein the supplementary weight information has been obtained by the communication device prior to or after the dynamic weighing event so that the vehicle does not stop on the weighing bridge during the dynamic weighing event;
generate a weighing ticket for the vehicle based on the received weight information and the received supplementary weight information.

12. The server according to claim 11, configured to at least one of
receive at least one of a position information, a speed, a direction and a timestamp for the vehicle at the dynamic weighing event from the communication device,
generate the weighing ticket further based on at least one of the position information, the speed, the direction and the timestamp received from the communication device; and
receive at least one of a speed, a direction and a timestamp for the vehicle (300) at the dynamic weighing event from the weighing scale,
generate the weighing ticket further based on at least one of the speed, the direction and the timestamp received from the weighing scale.

13. The server according to claim 12, configured to at least one of
determine an identity of the vehicle based on at least one of the position information, the speed, the direction and the timestamp at the dynamic weighing event;
receive an identity of the vehicle from the communication device;
receive an identity of the weighing scale from the communication device;
receive an identity of the vehicle from the weighing scale; and
receive an identity of the weighing scale from the weighing scale.

14. The server according to claim 13, configured to
generate the weighing ticket further based on at least one of: the identity of the vehicle determined by the server, the identity of the vehicle received from the communication device, the identity of the weighing scale received from the communication device, the identity of the vehicle received from the weighing scale, and the identity of the weighing scale received from the weighing scale.

15. A system for dynamic weighing of vehicles, the system comprising at least one communication device and at least one server according to claim 1 and further comprising at least one weighing scale.
